(19) United States
(12) Patent Application Publication
(10) Pub. No.: US 2024/0333756 A1
(43) Pub. Date: Oct. 3, 2024

(54) Malicious OSI Layer 7 Flow Detection with Dynamic Rule Engine and Traffic Inspection Subsystem

(71) Applicant: Threat X, Inc., Boston, MA (US)

(72) Inventors: Andrius Useckas, Boulder, CO (US); Alex Gatz, Hope, MI (US); Javier Rivera, Tampa, FL (US); Tyson Nottingham, Bellevue, WA (US)

(21) Appl. No.: 18/590,407

(22) Filed: Feb. 28, 2024

Related U.S. Application Data
(60) Provisional application No. 63/455,655, filed on Mar. 30, 2023.

(51) Int. Cl. H04L 9/40

(52) U.S. Cl. CPC H04L 63/1441; H04L 63/168

(57) ABSTRACT

A computer-implemented system captures raw Internet Protocol (IP) packets using a traffic inspection subsystem (e.g., an extended Berkeley packet filter (eBPF) subsystem). It then reassembles the raw IP flows into Layer 7 (OSI model application layer) flows. Once the Layer 7 protocol flows (e.g., HTTP, FTP, SMTP) are reassembled, the system may apply dynamic contextual rules to the reassembled flows to determine whether the client communicating with an application being protected has any malicious intent. If the system identifies any such malicious intent, the system blocks further communications from the client, such as by dropping requests, rejecting requests with a custom response, or other means.

### BACKGROUND

Various network security sensors (such as an Intrusion Detection System (IDS), Intrusion Prevention System (IPS), firewall, proxy, or Unified Threat Management (UTM) system) may be deployed “in-line” with the applications that they monitor. This involves placing a security device and/or software component within the network path of the application traffic flow. This type of network security sensor is typically designed to monitor and analyze the network traffic in real-time and identify potential threats or attacks targeting the application.

When a network security sensor is deployed in-line with applications, it acts as a gatekeeper, examining all incoming and outgoing traffic that flows through the network. If the sensor identifies any suspicious activity or malicious behavior, it can block the traffic or alert the security team to investigate further.

By deploying a network security sensor in-line with applications, organizations can gain better visibility into their network traffic and detect and prevent potential threats before they can cause damage. It also enables organizations to monitor the performance and availability of their applications in real-time, ensuring that they are always up and running smoothly.

Although deploying network security sensors in-line has the advantages described above, such in-line deployment also has drawbacks. For example, in-line deployment can increase the complexity of the network infrastructure, as additional devices or software components are required to be added to the network. This can lead to increased management and maintenance overhead and can make it more challenging to troubleshoot network issues.

In-line deployment can also lead to performance degradation. For example, in-line network security sensors may introduce additional latency or processing overhead as they analyze network traffic. This can impact application performance, especially if the network traffic is high.

Deploying network security sensors in-line can be expensive, as it requires the purchase and maintenance of additional hardware or software components. Additionally, the increased complexity and potential for performance degradation may require additional resources to manage and maintain the network.

What is needed, therefore, are network security sensors which address the existing drawbacks of in-line deployment.

### SUMMARY

A computer-implemented system captures raw Internet Protocol (IP) packets using a traffic inspection subsystem (e.g., an extended Berkeley packet filter (eBPF) subsystem). It then reassembles the raw IP flows into Layer 7 (OSI model application layer) flows. Once the Layer 7 protocol flows (e.g., HTTP, FTP, SMTP) are reassembled, the system may apply dynamic contextual rules to the reassembled flows to determine whether the client communicating with an application being protected has any malicious intent. If the system identifies any such malicious intent, the system blocks further communications from the client, such as by dropping requests, rejecting requests with a custom response, or other means.

Other features and advantages of various aspects and embodiments of the present invention will become apparent from the following description and from the claims.

### BRIEF DESCRIPTION OF THE DRAWINGS

FIG. 1 is a flowchart of a method for identifying and blocking network communication flows identified as having malicious intent according to one embodiment of the present invention.

FIG. 2 is a diagram of a system that performs the method of FIG. 1 according to one embodiment of the present invention.

### DETAILED DESCRIPTION

A computer-implemented system captures raw Internet Protocol (IP) packets using a traffic inspection subsystem (e.g., an extended Berkeley packet filter (eBPF) subsystem). It then reassembles the raw IP flows into Layer 7 (OSI model application layer) flows. Once the Layer 7 protocol flows (e.g., HTTP, FTP, SMTP) are reassembled, the system may apply dynamic contextual rules to the reassembled flows to determine whether the client communicating with an application being protected has any malicious intent. If the system identifies any such malicious intent, the system blocks further communications from the client, such as by dropping requests, rejecting requests with a custom response, or other means.

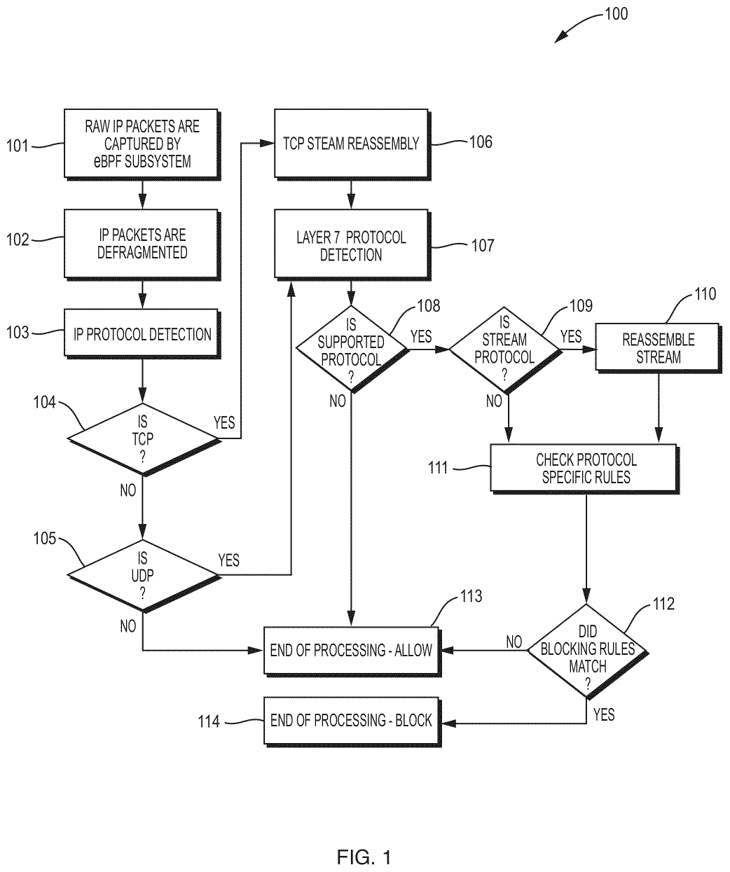

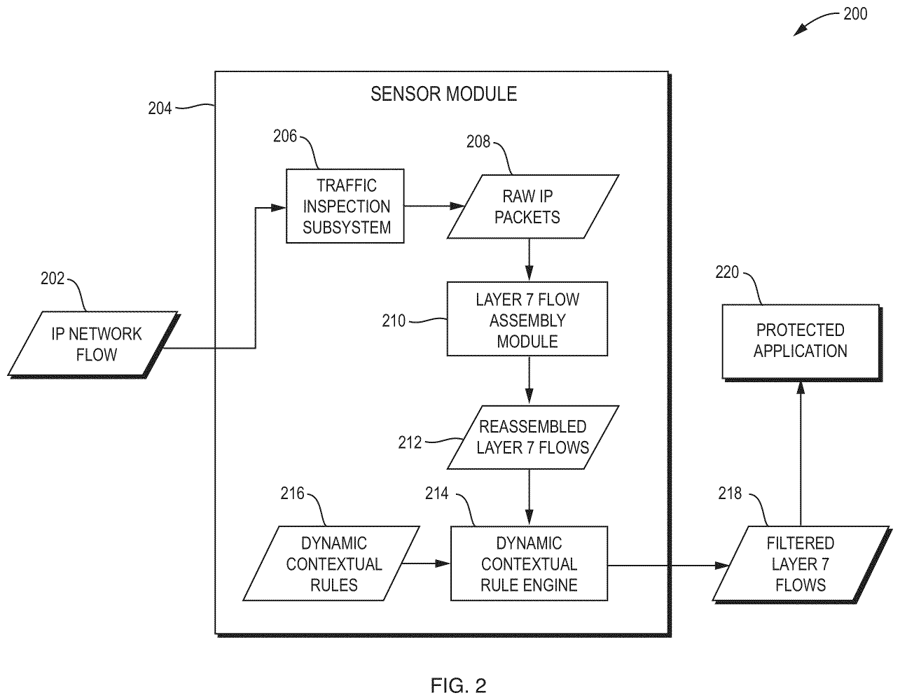

For example, referring to FIG. 1, a flowchart is shown of a method 100 for identifying and blocking network communication flows identified as having malicious intent according to one embodiment of the present invention. Referring to FIG. 2, a diagram of a system 200 that performs the method 100 of FIG. 1 according to one embodiment of the present invention.

In general, the system 200 of FIG. 2 receives an IP network flow 202 that has, as its destination, an application 220, referred to herein as the “protected application 220.” The IP network flow 202 may be any type of IP network flow, such as any unicast, multicast, or broadcast network flow, an IP network flow using any version of IP (e.g., IPv4 or IPv6), an HTTP flow, an SMTP flow, an IMAP flow, a TCP flow, or a UDP flow. Although FIG. 1 shows a single IP network flow 202 for ease of illustration, any of the techniques disclosed herein may be applied to any number of IP network flows, including a plurality of IP network flows of different types, in serial and/or in parallel.

The IP network flow 202 may specify that the protected application 220 as its destination in any of a variety of ways, such as by using one or more IP addresses and one or more port numbers. When data (such as the IP network flow 202) is sent over a network such as the Internet, each packet includes a header that contains the source IP address, the destination IP address, the source port, and the destination port, among other information. The combination of these elements allows the network to route the packets to the correct destination. The destination IP address in the packet header indicates the target device or server where the protected application 220 is hosted. This address is used by the network routers to forward the packet through the Internet to reach the correct network and ultimately the specific device. The destination port number is used to identify the specific service or application on the target device. Each application or service that listens for incoming connections is associated with a unique port number. For example, HTTP traffic commonly uses port 80, while HTTPS uses port 443. In the context of the system 200 of FIG. 2, the sensor module 204 may receive the IP network flow 202, and by examining the destination IP address and port number, the sensor module 204 may determine that the IP network flow 204 is intended for the protected application 220. The system 200 may then process the IP network flow 204 as disclosed herein.

The protected application 220 may be any type of application, including, but not limited to, a web application, an email server, a file transfer application, a Voice over Internet Protocol (VoIP) server, a streaming media server, an online gaming server, or a remote access server (e.g., a Remote Desktop or Virtual Private Network (VPN) client). Although FIG. 1 shows a single protected application 220 for ease of illustration, any of the techniques disclosed herein may be applied to any number of protected applications, including a plurality of protected applications of different types, in serial and/or in parallel.

The system 200 also includes a sensor module 204. The sensor module 204 may, for example, be implemented in software, which may execute on the same computer as the protected application 220. The sensor module 204 receives the IP network flow 202. The sensor module 204 may receive the IP network flow 202 in any of a variety of ways. For example, the sensor module 204 may include a traffic inspection subsystem 204. The traffic inspection subsystem 204 may, for example, use one or more extended Berkeley packet filter (eBPF) subsystems 206 to perform any of the functions disclosed herein.

eBPF, however, is merely one example of a technology that may be used to perform the functions disclosed herein, and embodiments of the present invention are not limited to using eBPF to perform such functions. As one example of another technology that may be used to perform various functions disclosed herein, nftables may be used to perform at least some of the blocking functions disclosed herein. As another example, iptables and/or netfilter may be used with custom chains to perform at least some of the blocking and/or alerting functions disclosed herein. These are merely examples of other technologies that may be used to perform various functions of embodiments disclosed herein, and do not constitute limitations of the present invention.

The traffic inspection subsystem 206 may capture raw Internet Protocol (IP) packets 208 from the IP network flow 202. The traffic inspection subsystem 206 may, for example, capture the raw IP packets 208 using one or more eBPF subsystems, which may, for example, use Express Data Path (XDP) and/or Traffic Control (TC) to capture the raw IP packets 208.

The traffic inspection subsystem 206 may disassemble the IP network flow 202 into individual raw IP packets 208. This disassembly process precedes the reassembly of Layer 7 flows that is described below. In particular, the traffic inspection subsystem 206 may segregate the IP network flow 202 into discrete packets. This may include, for example, parsing the IP network flow 202's data stream to identify the boundaries of each packet based on the underlying network protocols. The traffic inspection subsystem 206 may, for example, examine the header information and payload of each packet, facilitating the identification of protocol-specific attributes and any fragmentation that may have occurred during transmission.

The disassembly process serves as a foundational step that enables the subsequent reassembly of the packets into coherent Layer 7 flows. By first disassembling the network flow, the sensor module 204 ensures that each packet is individually accounted for and analyzed, thereby enhancing the accuracy and efficacy of the security measures applied during the reassembly phase described below.

As mentioned above, the traffic inspection subsystem 206 may use technology such as one or more extended Berkeley packet filter (eBPF) subsystems to perform functions such as disassembling the IP network flow 202 into the raw IP packets 208. In general, eBPF is a virtual machine-based technology with origins in the Linux kernel that allows for the efficient and flexible processing of network packets and other types of data. The eBPF virtual machine runs sandboxed programs in a privileged context, such as the operating system kernel, where they may be used to inspect and modify network packets as they pass through the system 200. This allows for real-time monitoring and analysis of network traffic, without the need for additional software or hardware, and without requiring changes to kernel source code or loading of additional kernel modules.

An eBPF program may be attached to a variety of kernel events, such as network packets arriving or leaving the system 200, system calls made by applications within the system 200, and kernel function calls. The same or different eBPF programs may be attached to different kernel events. When an event to which an eBPF program is attached occurs, that eBPF program may be executed, and that eBPF program may inspect or modify the data associated with the event.

One of the key benefits of eBPF is its performance. eBPF drastically improves processing by being JIT-compiled and running directly in the kernel. Because eBPF programs run within the kernel, they have access to the full power of the system 200's hardware, including multiple CPU cores and specialized hardware features. This allows for high-performance packet processing and real-time analysis of network traffic.

Furthermore, eBPF programs are verified to not crash the kernel and can only be modified by privileged users. Use of eBPF makes it possible to modify and add functionality and use cases to the kernel without having to restart or patch it.

The system 200, and embodiments of the present invention more generally, may benefit from and build upon these benefits of eBPF to produce an improved system for detecting and blocking malicious network traffic, as will now be described in more detail. Although eBPF is one particularly beneficial way to implement some or all of the functions performed by the traffic inspection subsystem 206, some or all of such functions may be implemented using technologies other than eBPF.

The sensor module 204 also includes a Layer 7 flow assembly module 210, which receives the raw IP packets 208 as input, and reassembles the raw IP packets 208 (flows) into one or more Layer 7 (OSI model application layer) flows, shown in FIG. 2 and referred to herein as reassembled Layer 7 flows 212 (FIG. 1, operation 101). Although element 212 is labeled and referred to in the plural as reassembled Layer 7 flows, in practice the IP network flow 202 may be disassembled by the sensor module 204 and then reassembled into one or more Layer 7 flow. As a result, it should be appreciated that any use of the term “flows” in relation to element 212 should be understood to refer to one or more Layer 7 flows.

The sensor module 204 also includes a dynamic contextual rule engine 214 and dynamic contextual rules 216. The dynamic contextual rules 216 are dynamic in the sense that they may change over time. At any point in time, the dynamic contextual rule engine 214 applies the current version of the dynamic contextual rules 216. For example, if a first version of the dynamic contextual rules 216 exists at a first time and the sensor module 204 calls the dynamic contextual rule engine 214 to process the reassembled Layer 7 flows 212 at that time, then the dynamic contextual rule engine 214 will apply the first version of the dynamic contextual rules 216 to those reassembled Layer 7 flows 212. If the dynamic contextual rules 216 subsequently change (e.g., by adding, deleting, or modifying one or more rules within the dynamic contextual rules 216), thereby creating a second version of the dynamic contextual rules 216 at a second time, and the sensor module 204 calls the dynamic contextual rule engine 214 to process the reassembled Layer 7 flows 212 at that time, then the dynamic contextual rule engine 214 will apply the second version of the dynamic contextual rules 216 to those reassembled Layer 7 flows 212.

The system 200 may enable the dynamic contextual rules 216 to be modified in any of a variety of ways. For example, the system 200 may enable users to publish new rules, which the system 200 may dynamically include within the dynamic contextual rules 216. As another example, the system 200 may automatically update the dynamic contextual rules 216 based on data such as threat intelligence feeds, updates from a central management server, or cloud-based services that provide information on emerging threats. As yet another example, the system 200 may use one or more machine learning algorithms to update the dynamic contextual rules 216, such as by analyzing traffic patterns and identifying anomalies that may signify new types of attacks. Once identified, the system 200 may use such anomalies to generate new rules or modify existing ones within the dynamic contextual rules 216. The system 200 may implement a feedback loop, in which the outcome of one or more rule applications (such as false positives or missed attacks) are analyzed to improve the accuracy and effectiveness of the dynamic contextual rules 216.

Regardless of how the dynamic contextual rules 216 are modified, the system 200 may update the dynamic contextual rules 216 to ensure that they remain effective against the latest threats, thereby maintaining the security and integrity of the protected application 220. The system 200 may enable any such modifications to the dynamic contextual rules 216 to be made without requiring that the sensor module 204 be redeployed in response to a modification to the dynamic contextual rules 216.

Once the Layer 7 protocol flows (e.g., HTTP, FTP, SMTP) have been reassembled into the Layer 7 flows 212, the dynamic contextual rule engine 214 may apply the dynamic contextual rules 216 to the reassembled Layer 7 flows 212 to determine whether the client that is attempting to communicate with the protected application 220 (i.e., the source of the IP network flow 202) has any malicious intent. If the dynamic contextual rule engine 214 identifies any such malicious intent as the result of applying the dynamic contextual rules 216 to the Layer 7 flows 212, the sensor module 204 may block further communications from the source of the IP network flow 202, such as by dropping requests from that source (e.g., using TCP Drop or HTTP response rewrite), rejecting requests from that source with a custom response, or other means. Any remaining (i.e., not blocked or dropped) flows are provided as filtered Layer 7 flows 218 to the protected application 220. As this implies, if any of the flows 212 are blocked by the sensor module 204, then the filtered flows 218 will include fewer than all of the flows 212.

Even more specifically, and now referring to FIG. 1 (which illustrates one method 100 that may be performed by the system 200 of FIG. 2), in some embodiments of the present invention, the sensor module 204 may use the traffic inspection subsystem 206 to capture raw Internet Protocol (IP) packets 208 from the IP network flow 202 (FIG. 1, operation 101).

As per RFC 792, it is possible for packets arriving on a network interface to be fragmented. The sensor module 204 may defragment and reassemble any such fragmented packets at OSI layer 3, also known as the network layer (FIG. 1, operation 102).

The sensor module 204 detects the underlying protocol of the raw IP packets 208 (FIG. 1, operation 103). The sensor module 204 determines whether the detected underlying protocol of the raw IP packets 208 is a stream protocol (e.g., TCP) (FIG. 1, operation 104). If the sensor module 204 determines that the detected underlying protocol of the raw IP packets 208 is a stream protocol (e.g., TCP), then the sensor module 204 reassembles the raw IP packets 208 into a stream of data according to that stream protocol (e.g., TCP) (FIG. 1, operation 106).

If the sensor module 204 determines that the detected underlying protocol of the raw IP packets 208 is not a stream protocol, then the sensor module 204 determines whether the detected underlying protocol of the raw IP packets 208 is UDP (FIG. 1, operation 105).

If the sensor module 204 determines that the protocol of the stream is not a stream protocol in operation 104 and is not User Datagram Protocol (UDP) in operation 105, the sensor module 204 may allow the flows to pass (FIG. 1, operation 113).

If the sensor module 204 determines that the detected underlying protocol of the raw IP packets 208 is a stream protocol (e.g., TCP), or QUIC riding on top of UDP protocol, or UDP, then the sensor module 204 (e.g., the flow assembly module 210) detects the OSI Layer 7 protocol of the raw IP packets 208 (or the TCP stream assembled in operation 106, if operation 106 was performed because the detected underlying protocol is a stream protocol) (FIG. 1, operation 107). Such protocol detection may be performed in any of a variety of ways, such as by looking for specific signatures or patterns that are unique to each Layer 7 protocol.

Although the diagram in FIG. 1 assumes that UDP and stream protocols are mutually exclusive, this is merely an example and is not a limitation of the present invention. For example, as the description above indicates, the techniques and principles disclosed herein may be applied to protocols (such as the HTTP/3 protocol), that are stream protocols and which use QUIC to ride on top of UDP. The method 100 of FIG. 1 may treat such protocols in the same way as UDP protocols.

The sensor module 204 determines whether the sensor module 204 supports the OSI Layer 7 protocol that was detected in operation 107 (FIG. 1, operation 108). If the detected OSI Layer 7 protocol is not supported, then the sensor module 204 may allow the raw IP packets 208 to pass (FIG. 1, operation 113). Such packets may be allowed, for example, in order not to block protocols merely because they are unsupported. Alternatively, however, the method 100 may be implemented to block the raw IP packets 208 if the sensor module 204 determines that the sensor module 204 does not support the OSI Layer 7 protocol that was detected in operation 107.

If the detected OSI Layer 7 protocol is supported, then the sensor module 204 determines whether the detected OSI Layer 7 protocol is a stream protocol (FIG. 1, operation 109). If the detected OSI Layer 7 protocol is determined to be a stream protocol, then the sensor module 204 (e.g., the flow assembly module 210) reassembles the stream into the Layer 7 stream 212 (FIG. 1, operation 110). Using HTTP as an example, the sensor module 204 may parse the stream, detect where packets begin and end, and then extract protocol-specific data such as URIs, headers, and request bodies.

If the stream is determined not to be a stream protocol in operation 109 or the stream is determined to be a stream protocol and it is reassembled into the reassembled Layer 7 flows 212 in operation 110, the sensor module 204 (e.g., the dynamic contextual rule engine 214) applies the dynamic contextual rules 216 to the stream (e.g., to the reassembled Layer 7 flows 212) (FIG. 1, operation 111). For example, the dynamic contextual rule engine 214 may apply, to the stream, protocol-specific rules based on the protocol of the stream. As this implies, the dynamic contextual rule engine 214 may apply only some of the dynamic contextual rules 216 (namely, only those rules within the dynamic contextual rules 216 which are applicable to the protocol of the stream) to the reassembled Layer 7 flows 212.

As this also implies, the dynamic contextual rule engine 214 may include multiple sets of protocol-specific rules, where each set corresponds to a distinct protocol. For example, the dynamic contextual rule engine 214 may include a first set of protocol-specific rules that is specific (corresponds) to a first Layer 7 protocol (e.g., HTTP), and also include a second set of protocol-specific rules that is specific (corresponds) to a second, different, Layer 7 protocol (e.g., FTP or SMTP). The sensor module 204 may identify, based on the protocol identified in operation 107, the set of protocol-specific rules (within the dynamic contextual rules 216) that corresponds to the identified protocol, and apply identified set of protocol-specific rules to the reassembled Layer 7 flows 212.

Consider two different instances of the IP network flow 202. If the sensor module 204 identifies a first protocol (e.g., HTTP) as being identified with a first instance of the IP network flow 202, then the sensor module 204 may identify a first set of protocol-specific rules (within the dynamic contextual rules 216) that is associated with the first protocol, and the dynamic contextual rule engine 214 may apply that first set of protocol-specific rules (e.g., HTTP-specific rules) to an instance of the flows 212 that results from the first instance of the IP network flow 202. If the sensor module 204 identifies a second protocol (e.g., FTP) as being identified with a second instance of the IP network flow 202, then the sensor module 204 may identify a second set of protocol-specific rules (within the dynamic contextual rules 216) that is associated with the second protocol, and the dynamic contextual rule engine 214 may apply that second set of protocol-specific rules (e.g., FTP-specific rules) to an instance of the flows 212 that results from the second instance of the IP network flow 202.

The ability to apply protocol-specific rules to the reassembled Layer 7 flows 212, based on the protocol of that flow 212, is important because different protocols have different characteristics and vulnerabilities, and thus require different security considerations. For example, if the reassembled Layer 7 flow 212 is an HTTP flow, the dynamic contextual rule engine 214 may apply rules that are specific to the HTTP protocol. These rules may, for example, include checks for SQL injection attacks in URL parameters, cross-site scripting (XSS) in form submissions, or other HTTP-specific anomalies. Similarly, if the flow 212 is an SMTP flow, the dynamic contextual rule engine 214 may apply a different set of rules that are tailored to email protocols, such as checks for spam or phishing attempts.

By applying only the relevant subset of the dynamic contextual rules 216, the dynamic contextual rule engine 214 may more efficiently and accurately assess the IP network flow 202 for potential threats. This targeted approach allows for a more optimized use of resources and reduces the likelihood of false positives, as the rules are finely tuned to the nuances of each protocol. It also allows for the dynamic contextual rules 216 to be updated and refined over time as new threats emerge or as the behavior of existing protocols evolves.

Although the dynamic contextual rules 216 may include any suitable rules, some examples of dynamic contextual rules that may be applied to HTTP traffic to detect various threats include:
SQL Injection Detection: Rules that look for patterns indicative of SQL injection attempts, such as the presence of SQL keywords (e.g., SELECT, DROP, INSERT) or syntactic elements (‘OR ‘1’=‘1, - - - , etc.) in query parameters, form data, or cookie values.
Cross-Site Scripting (XSS) Prevention: Rules that search for scripts or HTML tags embedded in user input that could be executed on the client side. This might include patterns like <script>, JavaScript, or event handlers like onload.
Command Injection: Rules that detect attempts to inject system commands into the server, often through form inputs or query strings, which could lead to unauthorized system access or control.
Path Traversal: Rules that look for sequences like . . . /or . . . \ in URL paths or file parameters that might indicate an attempt to access files or directories outside of the web server's root directory.
Buffer Overflow: Rules that trigger on unusually large request sizes or on specific patterns known to exploit buffer overflow vulnerabilities.
HTTP Method Enforcement: Rules that ensure only allowed HTTP methods (e.g., GET, POST) are used and block uncommon methods (e.g., PUT, DELETE) that might be leveraged for malicious purposes if not properly handled by the application.
Header Inspection: Rules that examine HTTP headers for anomalies, such as missing or unusual user-agent strings, referrer headers that don't match expected values, or suspiciously formatted cookies.
Rate Limiting: Rules that limit the number of requests from a single client within a certain timeframe to prevent denial-of-service attacks or brute force attempts.
File Upload Monitoring: Rules that scrutinize file uploads for disallowed file types, excessively large files, or content that could contain malware or scripts.
Known Vulnerability Targeting: Rules that block access to URLs or parameters known to be vulnerable in certain applications or frameworks, such as outdated plugins or known insecure endpoints.
Behavioral Anomalies: Rules that identify patterns of behavior that deviate from the norm, such as a high number of error responses, which could indicate a scanning or probing attempt.

The sensor module 204 determines whether any blocking rules in the applied rules match the stream (FIG. 1, operation 112). If any blocking rules are determined to match the stream in operation 112, then the sensor module 204 blocks the stream, thereby preventing the stream from being provided (within the filtered Layer 7 flows 218) to the protected application 220 (FIG. 1, operation 114). If no blocking rules are determined to match the stream in operation 112, then the sensor module 204, then the sensor module 204 allows the stream to pass (within the filtered Layer 7 flows 218) to the protected application 220 (FIG. 1, operation 113).

As can be seen from the description above of the method 100 of FIG. 1 and the system 200 of FIG. 2, that method 100 and system 200 apply the dynamic contextual rules 216 to determine whether the Layer 7 flow 212 is associated with malicious intent, and selectively block or allow the Layer 7 flow 212 based on that determination, wherein blocking the Layer 7 flow 212 prevents further communication from a source of the IP network flow 202 to the protected application 220, and wherein allowing the Layer 7 flow 212 permits communication from the source of the IP network flow 202 to reach the protected application 220.

The system 200 of FIG. 2 is illustrated in terms of functional modules and their respective inputs and outputs. The functions performed by the system 200 of FIG. 2 may be implemented in any of a variety of ways. For example, any particular module shown in FIG. 2 may be implemented in one or a plurality of modules. Such a plurality of modules may, for example, be implemented on a single device (e.g., computer) or be distributed across a plurality of devices. As merely one example of this, the eBPF subsystem 204 and Layer 7 flow assembly module 210 may be implemented in a sensor which is in communication over a network (e.g., the Internet) with the dynamic contextual rule engine 214, which may serve the dynamic contextual rules 216 to the sensor, e.g., via a cloud API.

Although certain functions are disclosed as being performed in kernel space using eBPF, some of the data disclosed herein may be passed to user space, and some of the functions disclosed (Layer 7 protocol reassembly, non-blocking rule checking, and other pre or post processing tasks) herein may be performed on such data in user space, to avoid restrictions associated with eBPF programs that execute in kernel space.

Embodiments of the present invention include a variety of novel features and advantages. For example, the method 100 and system 200 capture raw network flows at a low level (e.g., the extended Berkeley packet filter (eBPF) level), reassemble them back into Layer 7 (OSI application layer) protocols, and apply dynamic contextual rules to the reassembled data, whereby a decision is made to either allow specific communication or block them, depending on whether the client is determined to have malicious intent.

Using a technology such as eBPF to capture and reassemble network flows achieves the security benefits of in-line sensor deployment, while avoiding the complexity of such deployment. More specifically, embodiments of the present invention enable seamless deployment in customers' environments because eBPF filter insertion does not require modifying the running application or inserting additional components (e.g., a reverse proxy) into the network path. Embodiments of the present invention may be inserted into the network stack without the need for traditional kernel modules or system-level patches. eBPF operates at a privileged level within the operating system kernel, allowing the system to capture and process IP packets efficiently while remaining transparent to the protected applications and the network infrastructure.

Deploying new security solutions often requires scheduled downtime to implement necessary changes. In contrast, embodiments of the present invention eliminate or significantly reduce the downtime typically associated with deploying network security sensors, by not interfering with the traffic flow or the operation of the protected applications. As a result, organizations can maintain operational continuity as embodiments of the present invention may be deployed without interrupting the flow of network traffic or the availability of applications. This is particularly important for mission-critical applications that demand high availability. The ability to deploy without additional components simplifies the management and maintenance of the network security infrastructure. It reduces the overhead associated with managing extra devices or software and streamlines the troubleshooting process, as there are fewer elements to consider when diagnosing network issues. Furthermore, the system's design allows for scalability without the typical constraints of in-line solutions. As the network grows or the security needs evolve, the system can be scaled to handle increased traffic or additional security rules without the need for extensive reconfiguration or additional hardware. In summary, the seamless deployment advantage of embodiments of the present invention provides organizations with a non-intrusive, efficient, and flexible solution for enhancing network security. It allows for quick and easy integration into existing environments, minimizing the impact on network performance and application availability while offering a scalable and manageable approach to network security.

Traditional network security systems often make decisions based on lower OSI layers, such as Layer 3 (Network Layer) or Layer 4 (Transport Layer), which primarily involve IP addresses and port numbers. In contrast, embodiments of the present invention operate at Layer 7, which allows such embodiments to inspect and analyze the actual content of the communications, such as HTTP requests, FTP commands, SMTP messages, and other application-level data. This level of visibility enables the system to understand the context of the traffic, not just the endpoints involved. This enables embodiments of the present invention to make real-time decisions at Layer 7 (application layer) of the OSI model, thus providing greater flexibility and accuracy in the rules than systems which make decisions at Layer 3 and 4. In particular, decisions made by embodiments of the present invention are not limited to being based on simple data points, such as source IP address, destination IP address, and destination port and can take into account Layer 7 protocol specific data such as Method, URI, and arguments in HTTP protocol.

By operating at Layer 7, the system can apply dynamic contextual rules that are sensitive to the application's protocol and behavior. This means that the system can make more informed decisions by considering factors such as the specific URLs being accessed, the behavior of a particular session, or the patterns of data being transferred. This contextual understanding is crucial for identifying sophisticated threats that would not be detected by simply examining IP addresses or port numbers. Real-time decision-making at Layer 7 allows the system to accurately identify and block malicious traffic with greater precision. It reduces false positives and negatives, as the system can differentiate between legitimate and malicious use of protocols. For example, it can allow a valid user to access a web application while blocking an attacker attempting to exploit a vulnerability in the same application.

Cyber threats are constantly evolving, and attackers often use sophisticated techniques to bypass traditional security measures. The ability of embodiments of the present invention to make real-time decisions at Layer 7 means it can quickly adapt to new attack vectors and apply updated rules without waiting for lengthy deployment cycles. Making decisions at Layer 7 also allows the system to block malicious traffic before it reaches the protected application or consumes significant processing resources. This preemptive action can reduce the overhead on the protected applications and the underlying operating system, as they are spared from processing potentially harmful traffic. By ensuring that only legitimate traffic reaches the protected application, the system can contribute to a better user experience. Applications perform better when they are not burdened with processing malicious requests, and users benefit from the reduced risk of encountering security incidents. In summary, the ability of embodiments of the present invention to make real-time decisions at Layer 7 provides a sophisticated approach to network security, enabling the system to make informed and precise decisions about network traffic. This capability allows for the detection and prevention of complex threats in real-time, ensuring a secure and efficient network environment.

Embodiments of the present invention enable malicious traffic to be dropped at the eBPF level, before network flows reach and are reassembled by the OS kernel. This has the benefit of reducing security risk as well as processing overhead in the kernel. This is particularly beneficial for high-throughput environments where the kernel might otherwise become a bottleneck due to the volume of traffic requiring inspection and reassembly.

The system's ability to drop malicious traffic before it reaches the application layer means that security risks are mitigated at an early stage. This preemptive approach to security can prevent attacks from reaching their intended targets, thereby reducing the potential for damage. Efficient traffic handling ensures that the system's performance is optimized, as legitimate traffic is processed with minimal delay. This is crucial for maintaining the responsiveness and availability of protected applications, especially those that are latency-sensitive.

Furthermore, the system's efficient approach to traffic handling allows it to scale more effectively. As network traffic volumes increase, the system can continue to provide robust security without a corresponding increase in processing overhead, making it suitable for growing or high-demand environments. By reducing the amount of unnecessary or malicious traffic that must be processed by the system, resources such as CPU cycles and memory are conserved. This conservation of resources can lead to cost savings, as it may reduce the need for additional hardware to handle increased traffic loads. In summary, the efficient traffic handling enabled by embodiments of the present invention ensures that network traffic is managed in a way that optimizes performance, conserves resources, and enhances security. By leveraging technology such as eBPF, embodiments of the present invention can handle traffic efficiently, allowing for scalability and robust protection against threats with minimal impact on the protected applications and the underlying infrastructure.

Furthermore, the dynamic contextual rule engine 214 provides users with the ability to flexibly publish rules that may be consumed by the sensor module 204 in a timely manner, without the need to redeploy the sensor module 204 every time a new rule is published or an existing rule is modified. Embodiments of the present invention provide greater rule tuning flexibility with less overhead than systems which employ static rule engines which need to be redeployed with each rule update.

The dynamic contextual rule engine 214, and the dynamic contextual rules 216 that it uses, represent a significant enhancement over static rule engines that require redeployment for updates. For example, the dynamic contextual rule engine 214 allows for the rapid publication and consumption of new rules or modifications to existing rules. This means that as soon as a new threat is identified or a new security policy is developed, the dynamic contextual rule engine 214 can be updated almost instantly to reflect these changes, without the need for a system restart or redeployment. Users have the flexibility to tailor the dynamic contextual rules 216 to their specific needs and can respond quickly to emerging threats. This adaptability is crucial in a landscape where threats can evolve rapidly, and the time window to respond to such threats is often very short.

Because the dynamic rule engine 214 does not require the sensor module 204 to be redeployed with each rule update, there is less overhead associated with maintaining the system. This also minimizes downtime or service interruptions, which is particularly beneficial for environments where continuous operation is critical. The system enables users to publish their own rules, providing a level of customization and control that allows organizations to enforce their unique security policies effectively. This user-defined rule capability ensures that the system can be finely tuned to the specific security context of the organization.

By allowing for dynamic updates, the dynamic contextual rule engine 214 ensures that only relevant and current rules are applied, which can improve the efficiency of resource utilization. The system does not waste resources on outdated rules that no longer apply to the current threat environment. The dynamic nature of the dynamic contextual rule engine 214 allows the system to be proactive rather than reactive. It can quickly implement defensive measures against new threats before they have a chance to cause harm, rather than waiting for the next scheduled update or system maintenance window. In summary, the dynamic contextual rule engine 214 provides the system with the agility to keep pace with the rapidly changing threat landscape. It offers a proactive, flexible, and efficient approach to network security, enabling organizations to maintain a robust defense against both known and emerging threats with minimal impact on system operations.

In some embodiments, the techniques described herein relate to a method performed by at least one computer processor executing computer program instructions stored on at least one non-transitory computer-readable medium, the method including: (A) capturing raw Internet Protocol (IP) packets using a traffic inspection subsystem; (B) reassembling the raw IP packets into an OSI Layer 7 flow; (C) applying a plurality of dynamic contextual rules to the OSI Layer 7 flow to determine whether to block the OSI Layer 7 flow; (D) if applying the plurality of dynamic contextual rules to the OSI Layer 7 flow determines that the OSI Layer 7 flow should be blocked, then, in response to such a determination, blocking the OSI Layer 7 flow; and (E) if applying the plurality of dynamic contextual rules to the OSI Layer 7 flow does not determine that the OSI Layer 7 flow should be blocked, then allowing the OSI Layer 7 flow.

The traffic inspection subsystem may include an eBPF subsystem, and (A) may include capturing the raw IP packets using the eBPF subsystem. Reassembling the raw packets into the OSI Layer 7 flow may include parsing application-level data in the raw IP packets.

The method may further include updating the plurality of dynamic contextual rules based on threat intelligence feeds.

Blocking the OSI Layer 7 flow may include dropping at least some of the raw IP packets.

Blocking the OSI Layer 7 flow may include rejecting a request from a source of the raw IP packets.

Rejecting the request may include rejecting the request with a custom response indicating that the raw IP packets have been rejected.

Operation (C) may include: (C)(1) identifying a protocol of the OSI Layer 7 flow; (C)(2) selecting, as the plurality of dynamic contextual rules, a plurality of rules that are specific to the identified protocol of the OSI Layer 7 flow; and (C)(3) applying the selected plurality of dynamic contextual rules to the OSI Layer 7 flow to determine whether to block the OSI Layer 7 flow.

The method may further include modifying at least one of the plurality of dynamic contextual rules without restarting or redeploying the traffic inspection subsystem.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically receive (e.g., intercept), disassemble, reassemble, inspect, and block/allow telecommunications network traffic automatically. Such functions are inherently rooted in computer technology and constitute an improvement to computer technology, and could not be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored on at least one non-transitory computer-readable medium, the method comprising:
(A) capturing raw Internet Protocol (IP) packets using a traffic inspection subsystem;
(B) reassembling the raw IP packets into an OSI Layer 7 flow;
(C) applying a plurality of dynamic contextual rules to the OSI Layer 7 flow to determine whether to block the OSI Layer 7 flow;
(D) if applying the plurality of dynamic contextual rules to the OSI Layer 7 flow determines that the OSI Layer 7 flow should be blocked, then, in response to such a determination, blocking the OSI Layer 7 flow; and
(E) if applying the plurality of dynamic contextual rules to the OSI Layer 7 flow does not determine that the OSI Layer 7 flow should be blocked, then allowing the OSI Layer 7 flow.

2. The method of claim 1, wherein the traffic inspection subsystem comprises an eBPF subsystem, and wherein (A) comprises capturing the raw IP packets using the eBPF subsystem.

3. The method of claim 1, wherein reassembling the raw packets into the OSI Layer 7 flow comprises parsing application-level data in the raw IP packets.

4. The method of claim 1, further comprising updating the plurality of dynamic contextual rules based on threat intelligence feeds.

5. The method of claim 1, wherein blocking the OSI Layer 7 flow comprises dropping at least some of the raw IP packets.

6. The method of claim 1, wherein blocking the OSI Layer 7 flow comprises rejecting a request from a source of the raw IP packets.

7. The method of claim 6, wherein rejecting the request comprises rejecting the request with a custom response indicating that the raw IP packets have been rejected.

8. The method of claim 1, wherein (C) comprises:
(C)(1) identifying a protocol of the OSI Layer 7 flow;
(C)(2) selecting, as the plurality of dynamic contextual rules, a plurality of rules that are specific to the identified protocol of the OSI Layer 7 flow; and
(C)(3) applying the selected plurality of dynamic contextual rules to the OSI Layer 7 flow to determine whether to block the OSI Layer 7 flow.

9. The method of claim 1, further comprising modifying at least one of the plurality of dynamic contextual rules without restarting or redeploying the traffic inspection subsystem.

10. A system comprising at least one non-transitory computer-readable medium having computer program instructions stored thereon, the computer program instructions being executable by at least one computer processor to perform a method, the method comprising:
(A) capturing raw Internet Protocol (IP) packets using a traffic inspection subsystem;
(B) reassembling the raw IP packets into an OSI Layer 7 flow;
(C) applying a plurality of dynamic contextual rules to the OSI Layer 7 flow to determine whether to block the OSI Layer 7 flow;
(D) if applying the plurality of dynamic contextual rules to the OSI Layer 7 flow determines that the OSI Layer 7 flow should be blocked, then, in response to such a determination, blocking the OSI Layer 7 flow; and
(E) if applying the plurality of dynamic contextual rules to the OSI Layer 7 flow does not determine that the OSI Layer 7 flow should be blocked, then allowing the OSI Layer 7 flow.

11. The system of claim 10, wherein the traffic inspection subsystem comprises an eBPF subsystem, and wherein (A) comprises capturing the raw IP packets using the eBPF subsystem.

12. The system of claim 10, wherein reassembling the raw packets into the OSI Layer 7 flow comprises parsing application-level data in the raw IP packets.

13. The system of claim 10, wherein the method further comprises updating the plurality of dynamic contextual rules based on threat intelligence feeds.

14. The system of claim 10, wherein blocking the OSI Layer 7 flow comprises dropping at least some of the raw IP packets.

15. The system of claim 10, wherein blocking the OSI Layer 7 flow comprises rejecting a request from a source of the raw IP packets.

16. The system of claim 15, wherein rejecting the request comprises rejecting the request with a custom response indicating that the raw IP packets have been rejected.

17. The system of claim 10, wherein (C) comprises:
(C)(1) identifying a protocol of the OSI Layer 7 flow;
(C)(2) selecting, as the plurality of dynamic contextual rules, a plurality of rules that are specific to the identified protocol of the OSI Layer 7 flow; and
(C)(3) applying the selected plurality of dynamic contextual rules to the OSI Layer 7 flow to determine whether to block the OSI Layer 7 flow.

18. The system of claim 10, wherein the method further comprises modifying at least one of the plurality of dynamic contextual rules without restarting or redeploying the traffic inspection subsystem.
